(19) United States
(12) Patent Application Publication
(10) Pub. No.: US 2007/0244574 A1
(43) Pub. Date: Oct. 18, 2007

(54) MODEL PARAMETER DETERMINATION APPARATUS AND METHOD

(75) Inventors: Shigeo ORII, Kawasaki (JP); Hirokazu ANAI, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/533,510

(22) Filed: Sep. 20, 2006

(30) Foreign Application Priority Data
Mar. 30, 2006 (JP) 2006-096046

(51) Int. Cl. G05B 13/02

(52) U.S. Cl. 700/31

(57) ABSTRACT

A model parameter determination program makes a computer execute the procedures of substituting variable values and differential values of variables computed by using initial values of variables and model parameters for a first-order formula corresponding to the model; substituting supposition values for unknown model parameters within the post-substitution first-order formula; and applying a quantifier elimination method to the formula after the aforementioned substitution, thereby obtaining an upper limit value of errors.

### BACKGROUND OF THE INVENTION

1. Field of the Invention

The present invention relates to a method for determining parameters of a model corresponding to a problem expressed by real algebraic constraints.

2. Description of the Related Art

While the present invention deals with a wide range of practical problems expressed by a first-order formula, that is, a formula with a qualifier, in various field of science and technology, yet the content of the present invention is described by mainly exemplifying an application to a biological system simulation herein.

It is desired to determine parameters of a model effectively in a field of analysis and design of a biological system by performing a simulation of a model of various systems relating to a biological body or a cell, i.e., a biological system model, e.g., a model of a glycolytic system.

That is, one problem concerned with the present invention is to comprehend a nature of a biological system, or an essence thereof based on a model, when time-sequence data values of variables of a biological system are given by a numerical simulation or an actual measurement corresponding to a model of the target biological system which is modeled by a hybrid Petri net (HPN) for example. The problem specifically is to obtain a feasible range of reaction coefficients as parameters of a model, obtain a feasible range of a remainder of parameters when some measurement values of the parameters of the model are known, validate existence of a solution of the model, and discover new knowledge on the biological system, for example.

In recent years, what is demanded is a development of an effective solution method satisfying such a requirement, keeping pace with research in biological technologies becoming increasingly active. Such a method is necessary, in quite a wide range, for an industrial design process of a biological system, e.g., resolution of a development mechanism of a disease, a preventive medical practice and a tailor-made medical practice. Conventionally, however, an effective method for appropriately satisfying such requirements has not been existent, and instead, the practiced is a method for determining desired parameter values, or estimating a property of a system, by a trial and error technique by repeating a numerical simulation using set-up various parameter values by utilizing a tool for carrying out a numerical simulation by constructing a biological system model, such as genomic object net (GON), visual object net and E-CELL, making the actual work very difficult and costly.

As a conventional technique relating to a determination method for model parameters in such a simulation, a patent document 1 has disclosed a technique for generating constraints relating to model parameters and applying a quantifier elimination method, i.e., a quantifier elimination (QE) algorithm, to the constraints, thereby figuring out a presence or absence of a solution and feasible range of parameters.

Meanwhile, a non-patent document 1 has disclosed a determination method of parameters for a biochemical model by likewise using a QE algorithm.

[Patent document 1] Laid-Open Japanese Patent Application Publication No. 2005-129015 “Model parameter determination method and determination apparatus for simulation”

[Non-patent document 1] Orii, S., Anai, H. and Horimoto, K.: “Symbolic-numeric estimation of parameters in biochemical models by quantifier elimination”; Proc. of the 2005 International Joint Conference of InCoB, AASBi and KSBI; 272-277, 2005

FIG. 1 is a flow chart of a conventional technique of a parameter determination method disclosed in the non-patent document 1.

F(\dot{X},X,K,eₘₐₓ,eᵢ)=

(ψ̂hᵢ(X)=0̂xᵢεDᵢ̂|eᵢ|≦eₘₐₓ̂\hat{x}ⱼ(t)−xⱼ(t)=0) [Expression 1]

In the first-order formula F, an X is a variable vector, a \dot{X}

is a vector of differential values of variables, a K is a parameter vector, an eₘₐₓ, which is a subject handled by the present invention, is for example an upper limit error value, and an eᵢ is an error term corresponding to constraint. The error term and the upper limit error value are described later.

And, in the first-order formula F, the ψ is a constraint condition, the h₁(X)=0 is the conservation of concentration, and the xᵢεDᵢ (Dᵢ=[a,b], a, bεR∪{∞}) is feasible range of variables. The

\hat{x}ⱼ(t)−xⱼ(t)=0 [Expression 2]

is an objective function indicating that a measurement value

\hat{x}ⱼ

shall be identical with a computed value xⱼ by a simulation, and the |eᵢ|≦eₘₐₓ shows that an absolute value of an error term eᵢ for each constraint shall be smaller than the upper limit error value eₘₐₓ.

Referring to FIG. 1, as a process is started, the step S100 sets values of an initial value X⁽⁰⁾ of a variable vector X and an initial value K⁽⁰⁾ of a parameter vector K, followed by the step S101 obtaining, by a numerical computation, a vector X and a

\dot{X}

, and the step S102 substituting values of the calculated variable vector and its differential vector

\dot{X}

for the first-order formula F, thereby obtaining a formula F′.

That is, the step S100 presumes an initial value for parameters of each element of the parameter vector K, which is basically unknown, and substitutes values of the vector X and of the \dot{X} numerically computed by using the initial value to the first-order formula F. In this case, values are not substituted for some elements among the elements of the variable vector, and values are substituted for the other variables, thereby forming the formula F′ in order to carry out calculations thereafter very precisely. That is, values of variables are not substituted for a vector Y which is constituted by some number of elements among the elements of the vector X, e.g. an n-piece from x₁ through xₙ

In the case that an offset value is to be introduced for considering an influence of a noise from a measurement instrument for example, the offset value is obtained in the step S103, the offset value is substituted for the formula F′ which has been formed in the step S102 and it is returned to the process of the S102 as new formula F′. If there is no need to consider an offset, the process of the step S102 is not carried out.

The subsequent step S104 applies a QE algorithm to the formula F′, thereby eliminating the unknown variable vector Y, parameter vector K and error term eᵢ, and obtaining the upper limit error value eₘₐₓ. Here, the eₘₐₓ indicates the upper limit value (which is an absolute value) of errors eᵢ (where i=1, 2 through n) corresponding to each of the n-number of variables x₁ through xₙ, for example, which is set for securing a convergence of the QE algorithm, and therefore the value of the eₘₐₓ shall be desirably as smaller as possible.

As the value of the eₘₐₓ is obtained, in the step S105 the QE algorithm is applied again by using the value in the subsequent step, thereby obtaining parameters which are actually unknown and for which initial values have been substituted by the process of the S100, a sum of square residual between a measured value of each variable and a computed value thereof by a simulation by using the parameters is computed in the step S106, followed by judging whether or not the value of the sum of square residual is equal to or less than a predefined threshold value in the step S107. If it is not equal to or less than the predefined threshold value, the processes of the step S100 and thereafter are iterated and, if a judgment is that it is equal to or less than the predefined threshold value, the values of the parameters are output in the step S108 and thus the process ends.

Also according to the technique presented by the patent document 1, an error term is introduced corresponding to each variable for example, the eₘₐₓ indicating the upper limit error value of each error term is designated for determining model parameters.

Generally, if data by a numerical simulation or an experiment are used for values of variables, a result is sometimes obtained that there is no solution according to a QE algorithm which computes by symbolic computation, even though there is actually a solution, because an error of a numerical computation or an observation error is included in the solution. Accordingly, the upper limit error value eₘₐₓ is added as a variable and a value of the eₘₐₓ is obtained by the QE algorithm, followed by the QE algorithm being applied again by using the value of the eₘₐₓ and determining the unknown parameters, also in the conventional technique.

In the case of obtaining an eₘₐₓ as the upper limit error value by applying the QE algorithm to a first-order formula, however, a size of a problem becomes large in proportion with the respective numbers of variables, unknown parameters and pieces of observation data, thereby increasing a computation time and a used memory volume, resulting in being faced with the problem of being unable to obtain a solution eventually. In other words, the time complexity of the QE algorithm generally increases doubly exponentially with a variable volume, being faced with the problem of being unable to obtain the upper limit error value eₘₐₓ within a range of a practical computation time, as a problem becomes a large scale.

### SUMMARY OF THE INVENTION

In consideration of the above described problem, the challenge of the present invention is to enable an execution of an arithmetic operation for obtaining the maximum value of error terms designated corresponding to individual variables, that is, an upper limit error value, within a practical length of time even if a scale of a problem for solution is large, thereby efficiently accomplishing a model parameter determination process as a result.

According to the present invention, a model parameter determination apparatus comprises a unit for substituting variable values and differential values of variables computed by using initial values of the variables and the model parameters for a first-order formula corresponding to the model; a unit for substituting supposition values for unknown model parameters for the first-order formula which is substituted by the variable values and differential values of variables; and a unit for applying a quantifier elimination method to the first-order formula which is substituted by the supposition parameters, thereby obtaining an upper limit error value corresponding to a plurality of error terms within the aforementioned first-order formula.

### BRIEF DESCRIPTION OF THE DRAWINGS

FIG. 1 is a flow chart of a conventional example of a model parameter determination process;

FIG. 2 is a fundamental functional block diagram of a model parameter determination program according to the present invention;

FIG. 3 is a chart describing an outline of a quantifier elimination (QE) method;

FIG. 4 is a chart exemplifying an application of the QE method to a constraint problem;

FIG. 5 is a functional configuration block diagram of a model parameter determination apparatus;

FIG. 6 is a detail flow chart of an initial value calculation process for an upper limit error value;

FIG. 7 is a detail flow chart of a minimum value calculation process for an upper limit error value;

FIG. 8 is a chart describing a mechanism of an HIV proteinase;

FIG. 9 is a chart exemplifying a value of model parameters for FIG. 8;

FIG. 10 is a chart describing an effect of shortening a computation time of an initial value of an upper limit error value;

FIG. 11 is a chart describing a computation time of a minimum value of an upper limit error value by a binary search; and

FIG. 12 is a diagram describing a loading of a program according to the present invention to a computer.

### DESCRIPTION OF THE PREFERRED EMBODIMENTS

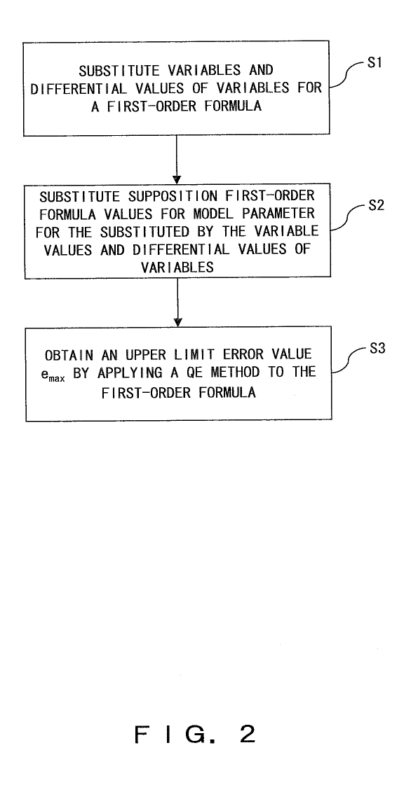

FIG. 2 is a fundamental functional block diagram of a model parameter determination program according to the present invention. Referring to FIG. 2, a procedure is executed by a computer in which the step S1 carries out the procedure of substituting, variable values and differential values of variables computed by using initial values of the variables and the model parameters for a first-order formula corresponding to a model, the step S2 carries out the procedure of substituting supposition values for unknown model parameters within the first-order formula, and the step S3 carries out the procedure of applying a quantifier elimination method thereto, thereby obtaining an upper limit error value eₘₐₓ which is common to a plurality of error terms within the first-order formula.

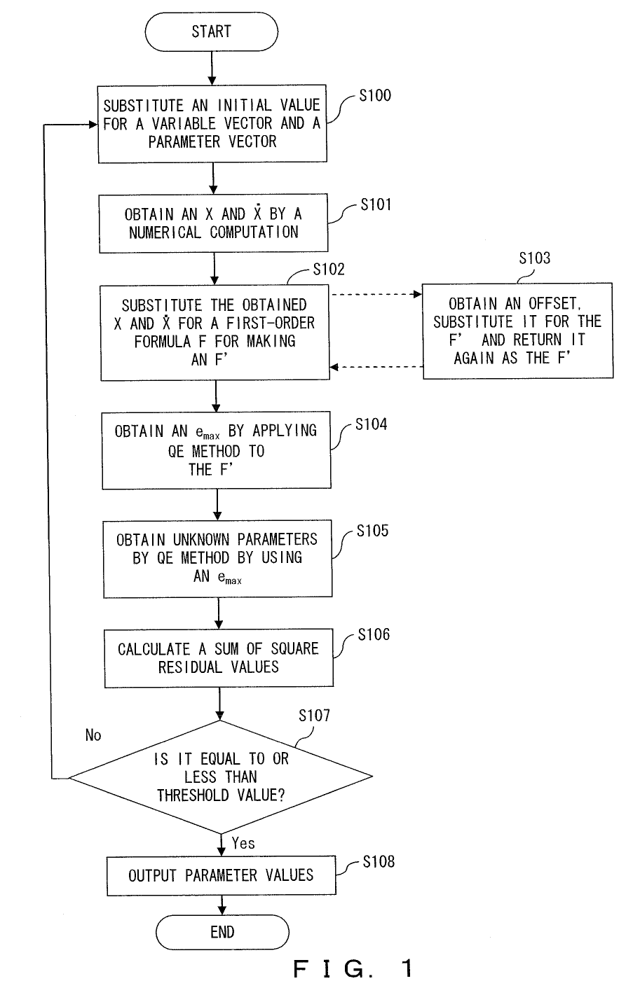

In an embodiment of the present invention, in the step S1, a subset vector Y of X may be chosen (vector Y has been explained for step S102 in FIG. 1), and the values of variables are not substituted for the vector Y. Thereafter, in the procedure of substituting supposition values for unknown parameters in the step S2, approximate values may be substituted for variables except for at least one or more among elements of the vector Y to decrease a number of the variables materially, thereby making the computation of the upper limit error value eₘₐₓ more efficient.

An embodiment of the present invention may also be configured in such a manner to further make a computer carry out the procedure of narrowing down the upper limit error value to a minimum value by taking the upper limit error value obtained in the step S3 as the initial value, and of determining values of unknown parameters by a quantifier elimination method by using the minimum value of the upper limit error value obtained by the narrow-down procedure.

Next, a model parameter determination apparatus according to the present invention comprises a unit for carrying out an operation equivalent to the process of the step S1, a unit for carrying out an operation equivalent to the process of the step S2 and a unit for carrying out an operation equivalent to the process of the step S3, which are shown in FIG. 2.

As described above, the present invention is contrived to apply a quantifier elimination method by substituting approximate supposition values for unknown parameters and variables of which an accurate value is unknown when obtaining an upper limit error value.

The present invention makes it possible to obtain an approximate value of an upper limit error value within a practical period of time, even if the number of variables or that of parameters increases, and further narrow it down to a minimum value by handling the upper limit error value as initial value, thereby determining values of unknown parameters by using the narrowed-down minimum value, thus contributing to a more effective model parameter determination process.

The present invention is contrived to obtain an approximate value of an upper limit error value which is common to error terms set for individual variables within a first-order formula for example, thereby enabling a more effective model parameter determination process when determining model parameters in order to resolve a mechanism of a biochemical reaction for example. Accordingly, the first description is of an outline of the quantifier elimination method.

Many industrial problems or mathematical problems are described as a formula including equations, inequalities, quantifiers, the Boolean operations, et cetera. Such formula is called a first-order formula, and an algorithm of a quantifier elimination (QE) method is one for forming an equivalent quantifier-free formula based on the given first-order formula.

The following reference document introducing an outline of the quantifier elimination method is available.

[Non-patent document 2] “Quantifier Elimination—Algorithm, implementation and application” authored by Anai, Hirokazu; Journal of Japan Society of Symbolic Algebraic Computation, Vol. 10, No. 1, pp 3-12 (2003)

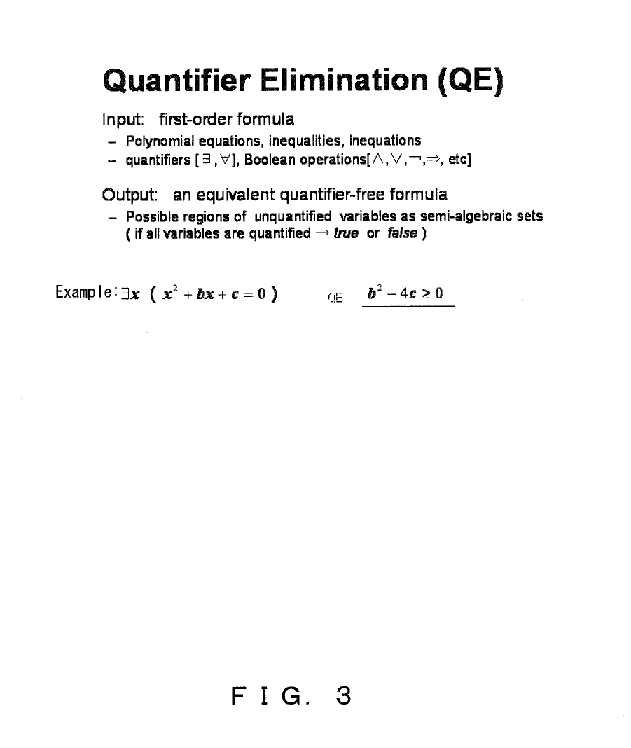

FIG. 3 is a chart describing the QE method. Referring to FIG. 3, an input is a first-order formula using polynomial equations, or inequalities, et cetera, and an output is a feasible range of a parameter without a quantifier. If all variables are quantified, it can be determined whether the problem is true or false, that is, whether or not the solution exists, and if the solution exists, the solution of a sample can be obtained. Such a problem is called a decision problem.

In FIG. 3, a formula b²−4c≧0 is obtained as an equivalent quantifier-free formula for the problem with a quantifier, that is, ∃×(x²+bx+c=0) with regard to a variable x.

In the case of quantifiers not existing for some variables, a formula which is quantifier-free and equivalent to a first-order formula is obtained by a QE algorithm. The obtained formula shows the possible range of remaining quantifier-free variables. In the case of such a range not existing, “false” is output. Such a problem is called a general quantifier elimination problem.

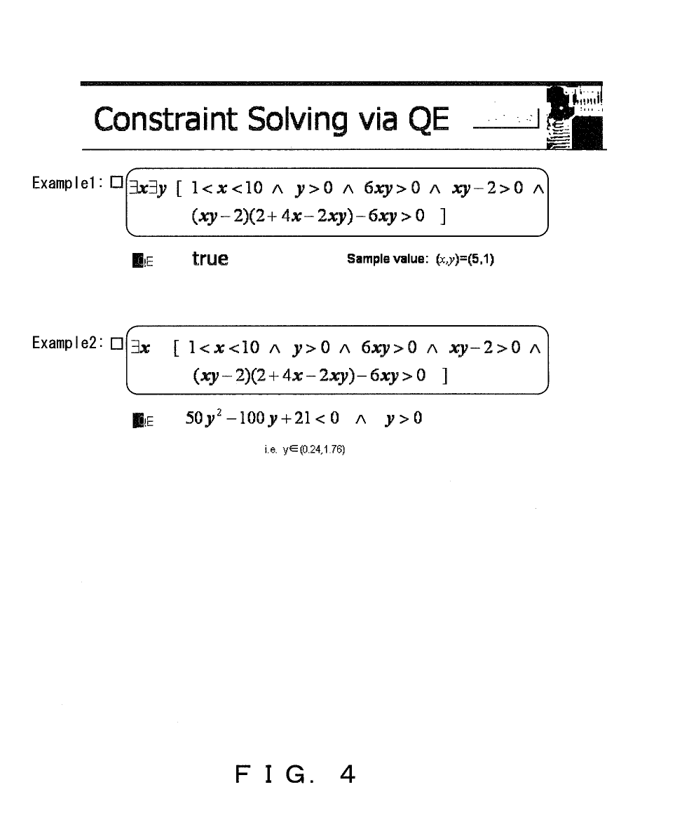

FIG. 4 is a chart describing an example of application of the quantifier elimination method to the solution of a specific constraint problem. Referring to FIG. 4, since quantifiers are attached to both of x and y in the example 1, the fact of “true” and the sample solution are output by the QE algorithm. In the example 2, since a quantifier is attached only to x, a feasible range of y as another variable is output by the QE algorithm.

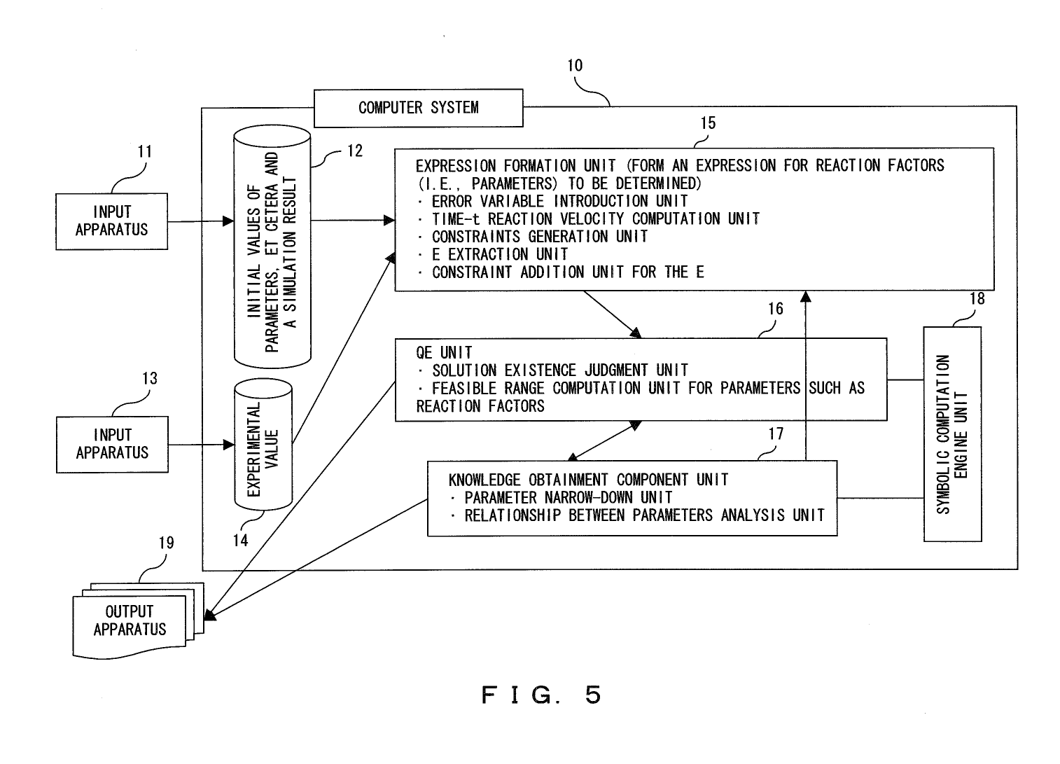

FIG. 5 is a functional configuration block diagram of a model parameter determination apparatus according to the present embodiment. The present embodiment is configured to perform a modeling of a biological system by using knowledge on biology for example, obtain a model suitable to a simulation and carry out a bio-simulation corresponding to the model.

In the configuration shown by FIG. 5, a computer system 10 receives inputs such as a simulation result and initial values of later described parameters, et cetera, by way of an input apparatus 11; and an experimental value, that is, an observation value by way of an input apparatus 13, which are stored in files 12 and 14, respectively.

Data within these files are input to an expression formation unit 15 for forming an expression of reaction factors, et cetera, as parameters for which its value or a feasible range is to be determined. The expression formation unit 15 comprises an error variable introduction unit for introducing an error variable in order to deal with an error against an experimental value, et cetera, as described later, a time-t reaction velocity computation unit for obtaining a velocity of a reaction at time t, constraints generation unit for making constraints for a constraint problem or an optimization problem, an E extraction unit for extracting an expression, as an E, including variables and error variables which are to be determined in order to add a constraint to variables or error variables as described later, and a constraint addition unit for the E.

Processes of a QE unit 16 and a knowledge obtainment component unit 17 are carried out by using a symbolic computation engine unit 18. The QE unit 16 comprises a solution existence judgment unit for judging a presence or absence of a solution by outputting “true” or “false”, and comprises a feasible range computation unit for parameters such as reaction factors. The knowledge obtainment component unit 17 comprises a parameter narrow-down unit and a relationship between parameters analysis unit. The QE unit 16 and the knowledge obtainment component unit 17 output the respective process results to an output apparatus 19, e.g., a printer or a display.

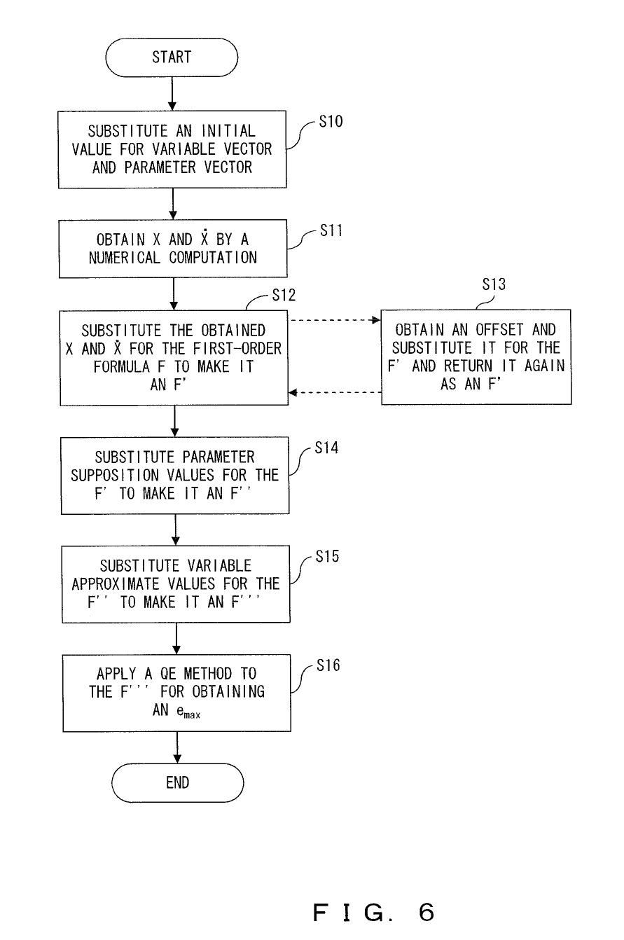

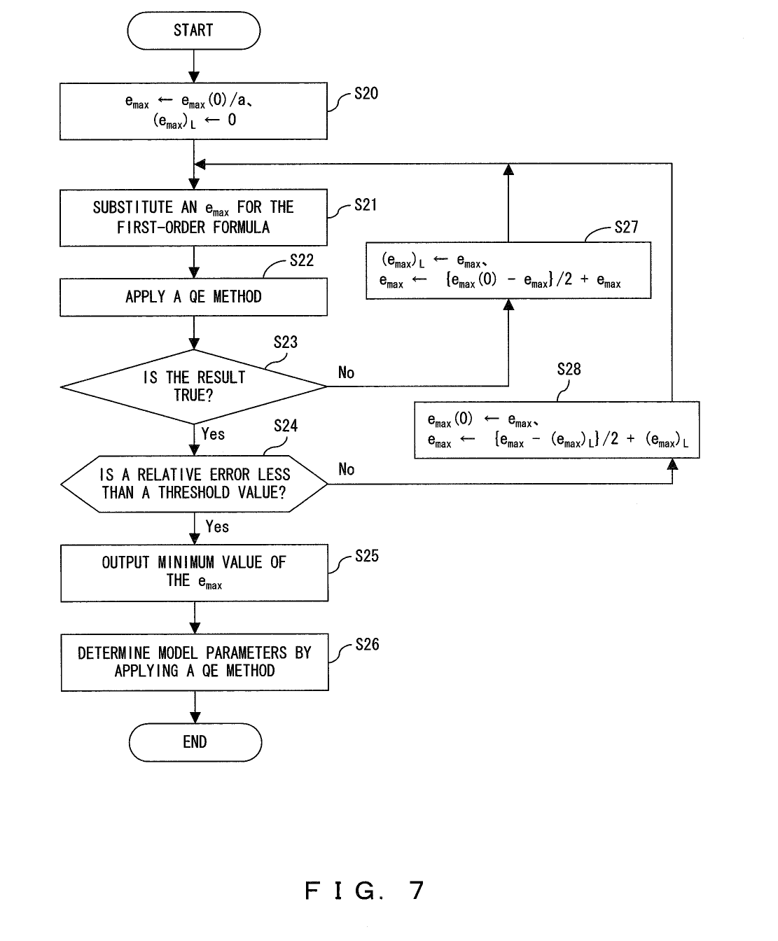

The following describes processes according to the present embodiment by referring to the flow charts shown by FIGS. 6 and 7. FIG. 6 is a flow chart of an initial value calculation process for an upper limit error value, which has improved a method for obtaining the upper limit error value according to the conventional technique which has been described in association with FIG. 1. Referring to FIG. 6, the processes of the steps S10 through S12 (including the process of step S13) are carried out in the same manner as those of the conventional example shown in FIG. 1. Also in the present embodiment, in the same manner as the step S102 in FIG. 1, a subset Y of X is chosen, the values of variables are not substituted for the vector Yin the step S12. For example, the variables substituted in the step S12 are limited to variables of which values obtained by a numerical computation are considered to have high degrees of accuracy. The variable vector Y constituted by a plurality of variables of which the accuracies are considered to be low are left as the unknown.

The subsequent step S14 substitutes supposition values for model parameters which are fundamentally unknown parameters, thereby obtaining a first-order formula F″ from the first-order formula F′ which has been obtained in the step S12.

The subsequent step S15 substitutes approximate values of variables, among variables as elements of an unknown vector Y, for which values have not been substituted in the step S12, of which the approximate values are obtainable if possible, for the first-order formula F″, thereby obtaining a first-order formula F′″. If there is no such variables of which approximate values are obtainable, the process of the step S15 is not carried out.

Lastly the step S16 applies the QE algorithm to the first-order formula F′″, obtains an initial value of the upper limit error value eₘₐₓ and ends the process. The conventional technique shown by FIG. 1 carries out the process applying a QE algorithm to the first-order formula F′ in the step S10 and obtains an upper limit error value eₘₐₓ without performing the processes of the steps S14 and S15 shown in FIG. 6, having been faced with the problem of increasing the computation time and usage memory volume drastically if a scale of the problem becomes large, and the numbers of parameters and/or variables increase, as described before, eventually resulting in being unable to obtain a solution. Whereas the present embodiment is configured to substitute supposition values for unknown parameters in the step S14 and further substitute approximate values for variables which are substitutable with the approximate values among variables of element (s) of an unknown vector Y in the step S15, followed by applying the QE algorithm, thereby making it possible to obtain an upper limit error value eₘₐₓ, even though it is an approximate value, within a range of practical computation time. Then, with this value of the eₘₐₓ as an initial value eₘₐₓ(0), performing a narrow-down process to a minimum value of the upper limit error value in the next process of FIG. 7 makes it possible to obtain the minimum value of the upper limit error value.

FIG. 7 is a detail flow chart of a minimum value calculation process for the upper limit error value. Referring to FIG. 7, as a process is started, the step S20 carries out an initialization process of initializing anew variable (eₘₐₓ)_{L}, to “0”, substituting, for eₘₐₓ, a result of dividing the upper limit error value eₘₐₓ(0), which has been obtained in the step S16 of FIG. 6, by an integer “a” for example, followed by carrying out the processes of the step S21 and thereafter.

The step S21 substitutes a value of an eₘₐₓ for the first-order formula as the target of applying a QE algorithm, the step S22 applies the QE algorithm and the step S23 judges whether the application result shows “true” or “false”.

If the application result of the QE algorithm shows “false”, the step S27 carries out the process of making the eₘₐₓ as (eₘₐₓ)_{L} and making an intermediate value between the eₘₐₓ and eₘₐₓ(0) as an eₘₐₓ, followed by continuing the processes of the step S21 and thereafter.

If the application result of the QE algorithm shows “true” in the step S23, the step S24 judges whether or not the relative error of |eₘₐₓ(0)−eₘₐₓ| relating to the eₘₐₓ is less than the threshold value θ. That is, the judgment is made according to the following expression:

$$\frac{\vert {e}_{max} ( 0 ) - {e}_{max} \vert}{{e}_{max}} < θ \qquad [ Expression 3 ]$$

If the relative error is judged to be not less than the threshold value in the step S24, the step S28 carries out the process of making the eₘₐₓ as an eₘₐₓ(0), and making an intermediate value between the eₘₐₓ and (eₘₐₓ)_{L} as an eₘₐₓ, followed by continuing the processes of the step S21 and thereafter, while if the relative error is judged to be less than the threshold value in the step S24, the eₘₐₓ is output as the minimum value of the upper limit error value in the step S25, and the step S26 applies QE algorithm to the first-order formula in order to determine model parameters, and the process ends. Incidentally, concrete examples of computation in the processes of FIGS. 6 and 7 are described later.

The following is a further description of an upper limit error value at the time of determining model parameters by using a specific example.

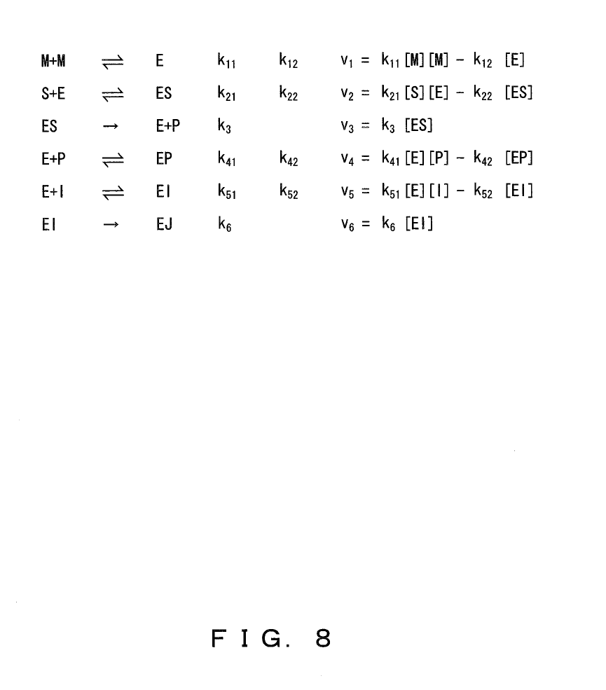

FIG. 8 is a chart describing the mechanism of the biochemical reaction of an HIV proteinase. Referring to FIG. 8, E is a proteinase, and causes the HIV to develop. I is an inhibitor of the HIV. P is the virus protein of developing the HIV, while S is precursor protein (i.e., a substrate). If E exists separately, it becomes equilibrium with M.

Referring to FIG. 8, a reaction velocity v₁ in the top reaction formula is determined by both a coefficient k₁₁ determining a velocity in the right direction and a coefficient k₁₂ determining a velocity in the left direction, for example. The proteinase E and precursor protein S, among these enzymes, can not start a reaction if they are zero (“0”) at time t=0, and therefore they are supposed as a positive value at t=0. The inhibitor I is externally provided and the virus protein P can be zero (“0”) at t=0.

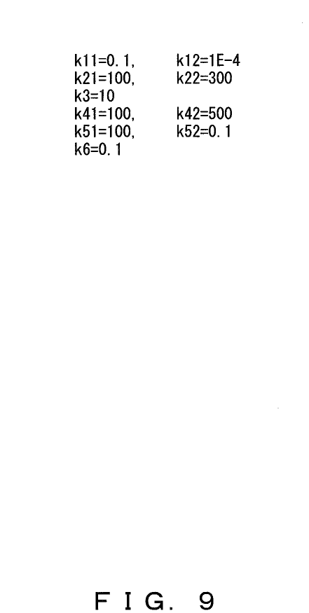

In the model shown by FIG. 8, ten coefficients, i.e., coefficients k₁₁ through k₆, which determine velocity of the respective reaction formulas are model parameters, and initial values at the fitting are presumably as given by FIG. 9. Note that the five coefficients, i.e., k₂₂, k₃, k₄₂, k₅₂ and k₆, among these ten coefficients, are model parameters as the target of determination in a QE algorithm, and therefore it is executed without using these values.

The model is expressed by the following ordinary differential equation by using reaction velocities v1 through v6 of the respective reaction formulas shown in FIG. 8:

$$\frac{d [ M ]}{d t} = - 2 \cdot {v}_{1} \\ \frac{d [ E ]}{d t} = {v}_{1} - {v}_{2} + {v}_{3} - {v}_{4} - {v}_{5} \\ \frac{d [ S ]}{d t} = - {v}_{2} \\ \frac{d \{ ES ]}{d t} = {v}_{2} - {v}_{3} \\ \frac{d [ P ]}{d t} = {v}_{3} - {v}_{4} \\ \frac{d [ EP ]}{d t} = {v}_{4} \\ \frac{d [ I ]}{d t} = - {v}_{5} \\ \frac{d [ EI ]}{d t} = {v}_{5} - {v}_{6} \\ \frac{d \{ EJ ]}{d t} = {v}_{6} \qquad [ Expression 4 ]$$

The following are constraints based on these differential equations.

$$ψ ( M , E , S , ES , P , EP , I , EI , EJ , JM , JE , JS , JES , JP , JEP , JI , JEI , JEJ , k 22 , k 3 , k 42 , k 52 , k 6 , erm , ere , ers , eres , erp , erep , eri , erei , erej , e max ) = erm + JM + 2 * ( 1 / 10 * M * M - 1 / 10000 * E ) = 0$$

$$and$$

$$ere + JE - ( ( 1 / 10 * M * M - 1 / 10000 * E ) - ( 100 * S * E - k 22 * ES ) + ( k 3 * ES ) - ( 100 * E * P - k 42 * EP ) - ( 100 * E * I - k 52 * EI ) ) = 0$$

$$and$$

$$ers + JS + ( ( 100 * S * E - k 22 * ES ) = 0 and \\ eres + JES - ( ( 100 * S * E - k 22 * ES ) - ( k 3 * ES ) ) = 0 \\ and \\ erp + JP - ( ( k 3 * ES ) - ( 100 * E * P - k 42 * EP ) ) = 0 \\ and \\ erep + JEP - ( 100 * E * P - k 42 * EP ) = 0 \\ and \\ eri + JI + ( 100 * E * I - k 52 * EI ) = 0 \\ and \\ erei + JEI - ( ( 100 * E * I - k 52 * EI ) - k 6 * EI ) = 0 \\ and \\ erej + JEJ - k 6 * EI = 0 \\ and \\ M >= 0 and E > 0 and S > 0 and ES >= 0 and P >= 0 and \\ EP >= 0 and I > 0 and EI >= 0 and EJ >= 0 and k 22 > 0 and \\ k 3 > 0 and k 42 > 0 and k 52 > 0 \\ and k 6 > 0 and - e max < erm < e max and \\ - e max < ere < e max and \\ - e max < ers < e max and \\ - e max < eres < e max and \\ - e max < erp < e max and \\ - e max < erep < e max and \\ - e max < eri < e max and \\ - e max < erei < e max and \\ - e max < erej < e max and \\ e max >= 0$$

Here, the constraints from the top through the ninth are obtained by replacing derivatives of above described differential equations as variables, for example, JM indicates dM/dt and substituting values to five parameters of FIG. 9. Generally, in the case of using data obtained by a numerical simulation or an experiment as values for variables, a numerical computation error or an observation error is included therein, and therefore a result of no solution may be sometimes obtained in a QE algorithm which performs an exact computation by symbolic computation, even though there is a solution. The present embodiment accordingly is configured to presume that a minor error is included in a computed value of each difference equation, prepare each difference equation by using variables of the error and apply the QE. Actually, constraints including error terms are prepared using nine error variables, i.e., erm, ere, ers, eres, erp, erep, eri, erei and erej obtained by attaching an “er” to the head of each variable, as error variables for the constraints. An equation ψ is obtained by adding to these constraints both an inequality equation for giving physical limitations to each variable and each model parameter, and each of inequality equations such that a maximum value of the absolute value of each error term is set emax.

First, supposed values are given to unknown parameters as follows:

% Starting parameters
k22 := 300;
k3 := 10;
k42 := 500;
k52 := 1/10;
k6 := 1/10;

Subsequently, a calculation of an offset is performed corresponding to the step S13 shown in FIG. 6 as follows:

% Compute offset
t3600_msd :=632629/1000000; % =0.632629
ofst := t3600_msd − 3/125*Sinit;

The present embodiment is configured to provide the QE unit 16 shown in FIG. 5 with values of variable values and differential values of variables respectively at three times as observation points (i.e., measurement values) as a QE input. And, first, an input to the QE unit 16 corresponding to the first time is as follows, where the expressions from the top to the ninth line represent the expressions through the ninth of the above described constraints ψ, and the tenth expression provides a value of a variable sgnl which is used for a measurement value:

```
    erm := − ( JM + 2*(1/10*M*M−1/10000*ee) );
    ere := − ( JEE − ((1/10*M*M−1/10000*ee) − (100*S*ee −
k22*ES)
    + (k3*ES) − (100*ee*P − k42*EP) − (100*ee*ii − k52*EI)) );
    ers := − ( JSS + (100*S*ee − k22*ES) );
    eres := − ( JES − ((100*S*ee − k22*ES) − (k3*ES)) );
    erp := − ( JPP − ((k3*ES) − (100*ee*P − k42*EP)) );
    erep := − ( JEP − (100*ee*P − k42*EP) );
    eri := − ( JII + (100*ee*ii − k52*EI) );
    erei := − ( JEIEI − ((100*ee*ii − k52*EI) −k6*EI) );
    erej := − ( JEJ − k6*EI );
    sgnl := 369873/1000000; % data No.=682, t=984,
signal=0.369873
    uqfin0:= (
    −M − 2*ee + 2*S + 2*P + 2*ii = − 2*Einit + 2*Sinit + 2*Iinit
and
    S + ES + P + EP = Sinit and
    M + 2*ee − 2*S − 2*P + 2*EI +2*Ej = 2*Einit − 2*Sinit and
    p − (sgnl − ofst)*1000/24 =0 and
    M>=0 and ee >0 and S >0 and ES >=0 and P>=0 and EP>=0 and
EI>=0 and EJ>=0 and
    k22>0 and k3>0 and k42>0 and k52>0 and k6>0 and
    (− emax <= erm <= emax and
    − emax <= ere <= emax and
    − emax <= ers <= emax and
    − emax <= eres <= emax and
    − emax <= erp <= emax and
    − emax <= erep <= emax and
    − emax <= eri <= emax and
    − emax <= erei <= emax and
    − emax <= erej <= emax) );
    uqfout0 := sub(
```

| time = 9840000000000/1000000000000*10**002, | % |
|---|---|
| 9.840000000000e+002 | |
| Iinit = 3000000000000/1000000000000/10**003, | % |
| 3.000000000000e−003 | |
| signal = 1887252952430/1000000000000/10**001, | % |
| 1.887252952430e−001 | |
| M = 2229085252834/1000000000000/10**005, | % |
| 2.229085252834e−005 | |
| SS = 1813582723453/1000000000000*10**001, | % |
| 1.813582723453e+001 | |
| ES = 4876923348145/1000000000000/10**004, | % |
| 4.876923348145e−004 | |
| PP = 7863553968458/1000000000000*10**000, | % |
| 7.863553968458e+000 | |
| EP = 1311046795513/1000000000000/10**004, | % |
| 1.311046795513e−004 | |
| ii = 1330477176374/1000000000000/10**005, | % |
| 1.330477176374e−005 | |
| EIEI = 5661674744077/1000000000000/10**007, | % |
| 5.661674744077e−007 | |
| EJ = 2986129060762/1000000000000/10**003, | % |
| 2.986129060762e−003 | |
| Einit = 3700000000000/1000000000000/10**003, | % |
| 3.700000000000e−003 | |
| Sinit = 2600000000000/1000000000000*10**001, | % |
| 2.600000000000e+001 | |
| Jtime = 5000000000000/(10**13)*(2**001), | % |
| 1.0000000000000 | |
| JIinit = 0, % 0.0000000000000 | |
| Jsignal = 9571837680298/(10**13)/(2**013), | % |
| 0.0001168437217 | |

JM = 5560137236768/(10**13)/(2**025), % 0.0000000165705

| | |
|---|---|
| Jee = −7348462184181/(10**13)/(2**029), | % |
| −0.0000000013688 | |
| JSS = −6231588486400/(10**13)/(2**007), | % |
| −0.0048684285050 | |
| JES = −5825875387525/(10**13)/(2**022), | % |
| −0.0000001388997 | |
| JPP = 6231665156586/(10**13)/(2**007), | % |
| 0.0048684884036 | |
| JEP = 6627088471687/(10**13)/(2**023), | % |
| 0.0000000790011 | |
| Jii = −8888929747922/(10**13)/(2**024), | % |
| −0.0000000529822 | |
| JEIEI = −6078516796086/(10**13)/(2**028), | % |
| −0.0000000022644 | |
| JEJ = 9268837038598/(10**13)/(2**024), | % |
| 0.0000000552466 | |
| JEinit = 0, % 0.0000000000000 | |
| JSinit = 0, % 0.0000000000000 | |
| uqfin0 ); | |
| Subsequently, an input to the QE unit 16 corresponding | |
| to the next time is as follows: | |
| erm := − ( JM + 2*(1/10*M*M−1/10000*ee1) ); | |

```
    ere := − ( JEE − ((1/10*M*M−1/10000*ee1) − (100*s1*ee1
− k22*ES)
    + (k3*ES) − (100*ee1*p1 − k42*EP) − (100*ee1*ii −
k52*ei1)) );
    ers := − ( JSS + (100*s1*ee1 − k22*ES) );
    eres := − ( JES − ((100*s1*ee1 − k22*ES) − (k3*ES)) );
    erp := − ( JPP − ((k3*ES) − (100*ee1*p1 − k42*EP)) );
    erep := − ( JEP − (100*ee1*p1 − k42*EP) );
    eri := − ( JII + (100*ee1*ii − k52*ei1) );
    erei := − ( JEIEI − ((100*ee1*ii − k52*ei1) −k6*ei1) );
    erej := − ( JEJ − k6*ei1 );
    sgnl := 36621/250000; % data (1) No.=628, t=336,
signal=0.146484
    uqfin1:=(
    −M − 2*ee1 + 2*s1 + 2*p1 + 2*ii = − 2*Einit + 2*Sinit +
2*Iinit and
    s1 + ES + p1 + EP = Sinit and
    M + 2*ee1 − 2*s1 − 2*p1 + 2*ei1 +2*Ej = 2*Einit − 2*Sinit
and
    p1 − (sgnl − ofst)*1000/24 =0 and
    M>=0 and ee1 >0 and s1 >0 and ES >=0 and p1>=0 and EP>=0
and ei1>=0 and EJ>=0 and
    k22>0 and k3>0 and k42>0 and k52>0 and k6>0 and
    (− emax <= erm <= emax and
    − emax <= ere <= emax and
    − emax <= ers <= emax and
    − emax <= eres <= emax and
    − emax <= erp <= emax and
    − emax <= erep <= emax and
    − emax <= eri <= emax and
    − emax <= erei <= emax and
    − emax <= erej <= emax) );
    uqfout1 := sub(
```

| | |
|---|---|
| time = 3360000000000/1000000000000*10**002, | % |
| 3.360000000000e+002 | |
| Iinit = 3000000000000/1000000000000/10**003, | % |
| 3.000000000000e−003 | |
| signal = 1007025285443/1000000000000/10**001, | % |
| 1.007025285443e−001 | |
| M = 1090949476872/1000000000000/10**005, | % |
| 1.090949476872e−005 | |
| SS = 2180325350548/1000000000000*10**001, | % |
| 2.180325350548e+001 | |
| ES = 7216956684414/1000000000000/10**004, | % |
| 7.216956684414e−004 | |
| PP = 4195938689347/1000000000000*10**000, | % |
| 4.195938689347e+000 | |
| EP = 8610950859596/1000000000000/10**005, | % |
| 8.610950859596e−005 | |
| ii = 2158705895960/1000000000000/10**004, | % |
| 2.158705895960e−004 | |
| EIEI = 1142462779546/1000000000000/10**005, | % |
| 1.142462779546e−005 | |
| EJ = 2772704782609/1000000000000/10**003, | % |
| 2.772704782609e−003 | |
| Einit = 3700000000000/1000000000000/10**003, | % |
| 3.700000000000e−003 | |
| Sinit = 2600000000000/1000000000000*10**001, | % |
| 2.600000000000e+001 | |
| Jtime = 5000000000000/(10**13)*(2**001), | % |
| 1.0000000000000 | |
| JIinit = 0, % 0.0000000000000 | |
| Jsignal = 7035347335850/(10**13)/(2**012), | % |
| 0.0001717614096 | |

JM = 6833982121443/(10**13)/(2**025), %0.0000000203669

| | |
|---|---|
| Jee = −9043060580504/(10**13)/(2**023), | % |
| −0.0000001078017 | |
| JSS = −9159408459733/(10**13)/(2**007), | % |
| −0.0071557878592 | |
| JES = −5201440220687/(10**13)/(2**019), | % |
| −0.0000009920960 | |
| JPP = 9160608510293/(10**13)/(2**007), | % |
| 0.0071567253987 | |
| JEP = 9153008209721/(10**13)/(2**024), | % |
| 0.0000000545562 | |
| Jii = −5427209515084/(10**13)/(2**019), | % |
| −0.0000010351581 | |
| JEIEI = −5593339296621/(10**13)/(2**023), | % |
| −0.0000000666778 | |
| JEJ = 5776793220764/(10**13)/(2**019), | % |
| 0.0000011018359 | |
| JEinit = 0, % 0.0000000000000 | |
| JSinit = 0, % 0.0000000000000 | |
| uqfin1 ); | |

Furthermore, an input to the QE unit 16 corresponding to the last third time is as follows:

```
    erm := − ( JM + 2*(1/10*M*M−1/10000*ee2) );
    ere := − ( JEE − ((1/10*M*M−1/10000*ee2) − (100*s2*ee2
− k22*ES)
    + (k3*ES) − (100*ee2*p2 − k42*EP) − (100*ee2*ii −
k52*ei2)) );
    ers := − ( JSS + (100*s2*ee2 − k22*ES) );
    eres := − ( JES − ((100*s2*ee2 − k22*ES) − (k3*ES)) );
    erp := − ( JPP − ((k3*ES) − (100*ee2*p2 − k42*EP)) );
    erep := − ( JEP − (100*ee2*p2 − k42*EP) );
    eri := − ( JII + (100*ee2*ii − k52*ei2) );
    erei := − ( JEIEI − ((100*ee2*ii − k52*ei2) −k6*ei2) );
    erej := − ( JEJ − k6*ei2 );
    sgnl := 566101/1000000; % data No.=754, t=1848,
signal=0.566101
    uqfin2:=(
    −M − 2*ee2 + 2*s2 + 2*p2 + 2*ii = − 2*Einit + 2*Sinit +
2*Iinit and
    s2 + ES + p2 + EP = Sinit and
    M + 2*ee2 − 2*s2 − 2*p2 + 2*ei2 +2*Ej = 2*Einit − 2*Sinit
and
    p2 − (sgnl − ofst)*1000/24 =0 and
    M>=0 and ee2 >0 and s2 >0 and ES >=0 and p2>=0 and EP>=0
and ei2>=0 and EJ>=0 and
    k22>0 and k3>0 and k42>0 and k52>0 and k6>0 and
    (− emax <= erm <= emax and
    − emax <= ere <= emax and
    − emax <= ers <= emax and
    − emax <= eres <= emax and
    − emax <= erp <= emax and
    − emax <= erep <= emax and
    − emax <= eri <= emax and
    − emax <= erei <= emax and
    − emax <= erej <= emax) );
    uqfout2 := sub(
```

| time = 1848000000000/1000000000000*10**003, | % |
|---|---|
| 1.848000000000e+003 | |
| Iinit = 3000000000000/1000000000000/10**003, | % |
| 3.000000000000e−003 | |
| signal = 2797735529326/1000000000000/10**001, | % |
| 2.797735529326e−001 | |
| M = 3668866233730/1000000000000/10**005, | % |
| 3.668866233730e−005 | |
| SS = 1434217229903/1000000000000*10**001, | % |
| 1.434217229903e+001 | |
| ES = 3965132539191/1000000000000/10**004, | % |
| 3.965132539191e−004 | |
| PP = 1165723137219/1000000000000*10**001, | % |
| 1.165723137219e+001 | |
| EP = 1998155229046/1000000000000/10**004, | % |
| 1.998155229046e−004 | |
| ii = 3777106832261/1000000000000/10**007, | % |
| 3.777106832261e−007 | |
| EIEI = 1652850731302/1000000000000/10**008, | % |
| 1.652850731302e−008 | |
| EJ = 2999605760809/1000000000000/10**003, | % |
| 2.999605760809e−003 | |
| Einit = 3700000000000/1000000000000/10**003, | % |
| 3.700000000000e−003 | |
| Sinit = 2600000000000/1000000000000*10**001, | % |
| 2.600000000000e+001 | |
| Jtime = 5000000000000/(10**13)*(2**001), | % |
| 1.0000000000000 | |
| JIinit = 0, % 0.0000000000000 | |
| Jsignal = 7784861579264/(10**13)/(2**013), | % |
| 0.0000950300486 | |

JM = 5662307413375/(10**13)/(2**025), % 0.0000000168750

| | |
|---|---|
| Jee = 5336027763135/(10**13)/(2**027), | % |
| 0.0000000039757 | |
| JSS = −5068251389866/(10**13)/(2**007), | % |
| −0.0039595713983 | |
| JES = −7645065759424/(10**13)/(2**023), | % |
| −0.0000000911363 | |
| JPP = 5068269257599/(10**13)/(2**007), | % |
| 0.0039595853575 | |
| JEP = 6474129079970/(10**13)/(2**023), | % |
| 0.0000000771776 | |
| Jii = −8297377108819/(10**13)/(2**029), | % |
| −0.0000000015455 | |
| JEIEI = −5745544012119/(10**13)/(2**033), | % |
| −0.0000000000669 | |
| JEJ = 8656473925608/(10**13)/(2**029), | % |
| 0.0000000016124 | |
| JEinit = 0, % 0.0000000000000 | |
| JSinit = 0, % 0.0000000000000 | |
| uqfin2 ); | |

Subsequently, an application result of the QE algorithm to such an input to the QE unit 16 is checked as follows:

```
%Check .true. or .false.
a:=ex({ee,ee1,ee2,S,P,EI,S1,P1,EI1,S2,P2,EI2,emax},uqfout0
and uqfout1 and uqfout2)$
    f_a:=rlqe(a);
    %Find emax
    a1:=ex({ee,ee1,ee2,S,P,EI,S1,P1,EI1,S2,P2,EI2},uqfout0
and uqfout1 and uqfout2)$
    f_a1:=rlqe(a1);
    emax:=(−part(f_a1,1,2)/part(f_a1,1,1,1));
    %Check .true. or .false.
    a2:=ex({ee,ee1,ee2,S,P,EI,S1,P1,EI1,S2,P2,EI2},uqfout0
and uqfout1 and uqfout2)$
    f_a2:=rlqe(a2);
    end$
```

That is, first, whether the application result of the QE algorithm is “true” or “false” is judged, and then the upper limit error value is obtained. Lastly here, the QE algorithm is applied again by using the computated value of the upper limit error value eₘₐₓ corresponding to the step S105 (shown in FIG. 1) of the conventional example, the process for obtaining unknown parameters is carried out and the result is checked for “true” or “false”. The present embodiment, however, is configured in such a manner that a value of the upper limit error value eₘₐₓ computed in the step S16 of FIG. 6 is used as the initial value eₘₐₓ(0), and the minimum value of the upper limit error value eₘₐₓ is computed by using the initial value according to the process flow chart shown by FIG. 7.

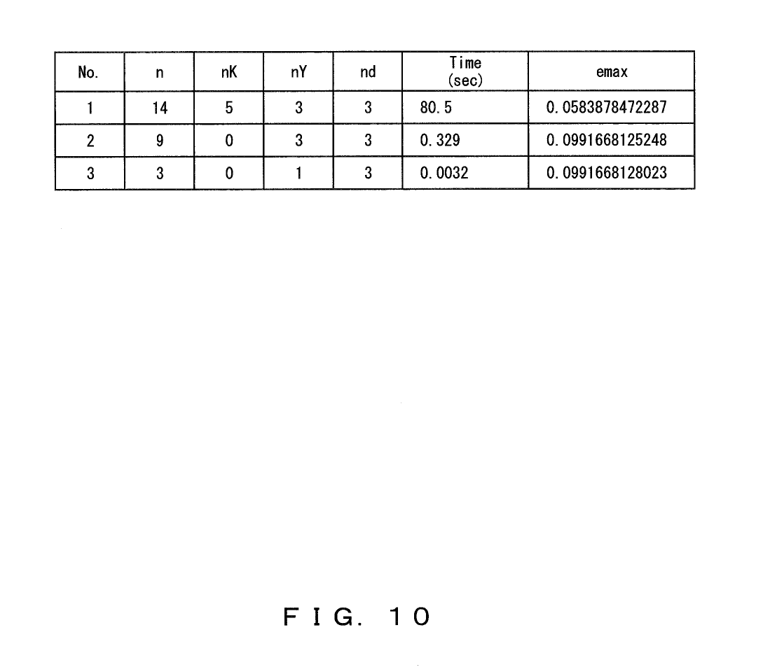

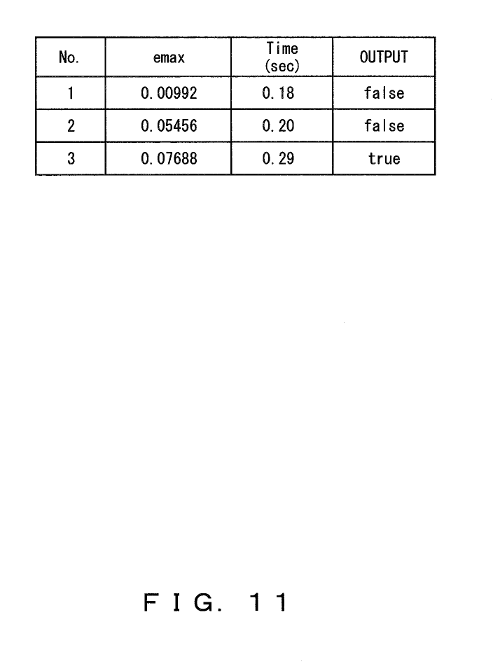

Relating to the process flow chart shown by FIGS. 6 and 7, an effect of shortening time for computed the initial value of the upper limit error value eₘₐₓ, and computation time for narrowing down the upper limit error value eₘₐₓ to the minimum value after the initial value is obtained, are explained by using FIGS. 10 and 11.

FIG. 10 is a chart describing an effect of shortening a computation time of the initial value of the upper limit error value. Referring to FIG. 10, No. 1 indicates computation time for the same process as the conventional example shown in FIG. 1. Here, it shows computation time corresponding to the case in which the number of observation points n_{d}=3, that is, observation values are those at three times, the number of variables for which a value has not been substituted, that is, the number of elements of the vector Y, i.e., n_{y}=3, and the number of unknown parameters nₖ=5, and time value is 80.5 seconds.

Comparably, No. 2 shows computation time for the case of substituting a supposition value for each of the five unknown parameters, in which the number of unknown parameters nₖ is reduced to zero (“0”), thereby reducing the computation time to 1/245 of that of No. 1.

Furthermore, No. 3 shows computation time in the case of substituting approximate values for two variables among three variables as elements of an unknown vector Y in addition to substituting a value for five unknown parameters, thereby reducing the computation time to 1/25000 of that of No. 1.

As such, as the values of the n which is calculated based on the following expression become smaller, i.e., in No. 1: 14, in No. 2: 9 and in No. 3: 3, the initial value of the upper limit error value eₘₐₓ can be obtained sufficiently within a range of a practical computation time:

n=nₖ+n_{y}*n_{d};

where the number of observation points is n_{d}, the number of variables is n_{y} for which a value has not been substituted and the number of unknown parameters is nₖ.

Note that it is necessary to leave at least one or more variables among elements of an unknown variable vector Y, for example, without a value being substituted for as the elimination target in symbolic computation of the QE algorithm for computing an initial value of the eₘₐₓ.

Generally, the value of the upper limit error value eₘₐₓ obtained by substituting approximate values for unknown variables, and supposition values for parameters, becomes larger than the value calculated by the conventional technique as described in association with FIG. 10. Although they rarely become the same, it is generally necessary to carry out a narrow-down process for bringing the value close to a value calculated by the conventional technique, that is, the minimum value. While this narrow-down process conceptually includes various methods, the present embodiment is configured to use a binary search method.

FIG. 11 is a chart describing the computation time by a binary search process described in association with FIG. 7. First, No. 1 is a result of taking an initial value eₘₐₓ(0), as 0.0992, of the upper limit error value eₘₐₓ obtained by the configuration of the present embodiment as described in association with FIG. 10, adopting a value of “a”, as “10”, in the process of step S20 shown in FIG. 7 and applying the QE algorithm in the step S22, resulting in a computation time of 0.18 seconds, and the result being “false”.

No. 2 shows a result of taking an intermediate value of 0.05456, as eₘₐₓ(0), between 0.0992 and 0.00992 in the step S27 of FIG. 7 and applying the QE algorithm, resulting in a computation time of 0.2 seconds and the application result also being “false”.

No. 3 shows a result of further taking an intermediate value of 0.07688, as eₘₐₓ(0), between 0.0992 and 0.05456 in the step S27 and applying the QE algorithm, resulting in the application result being “true”. Even though the application result is judged to be true in the step S23 of FIG. 7, the process of the step S28 is followed by repeating the processes of the step S21 and thereafter if the relative error is judged to be not less than the threshold value in the step S24. In this event, since the value of the eₘₐₓ is swung to a smaller side and the QE algorithm is applied, the application result is sometimes judged again to be “false” in the step S23. In any event, the minimum value of the upper limit error value is output in the step S25 at the time of the relative error being judged to be less than the threshold value during the repetition of the steps S21 through S28, model parameters are determined by using the minimum value in the step S26.

Also in the computation through No. 3 described in association with FIG. 11, the first significant figure appears in the same position of the computation results of No. 2 and No. 3, that is, at the second digit below the decimal point, thus the values of the eₘₐₓ converging within the range of one significant figure. Therefore, if the computation of No. 2 is used in FIG. 10, an overall time consumed for the computation of No. 3 in FIG. 11 is 0.999 seconds. Making the number of significant figure smaller appropriately shortens the time for computing the minimum value of the upper limit error value as compared to the computation time of the conventional technique, thereby enabling a use of the method according to the present invention as a powerful method for computing the minimum value of the upper limit error value, even though approximately, within a practical computation time, as compared to the method of the conventional technique which is faced with a case of being unable to obtain a value of the upper limit error value per se.

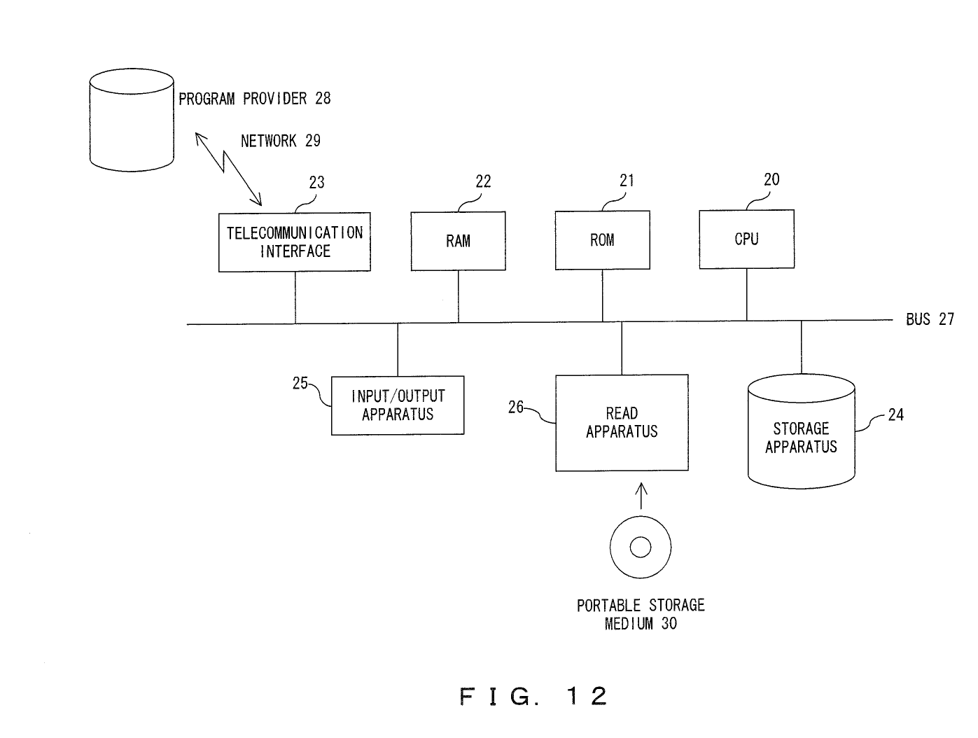

As such, the details of the model parameter determination program according to the present invention have been described. A model parameter determination apparatus using the program can apparently be configured basically by a common computer system. FIG. 12 is a configuration block diagram of such a computer system, that is, a hardware environment.

Referring to FIG. 12, the computer system comprises a central processing unit (CPU) 20, read only memory (ROM) 21, random access memory (RAM) 22, a telecommunication interface 23, a storage apparatus 24, an input and output apparatus 25, a portable storage media read apparatus 26 and a bus 27 interconnecting all of the aforementioned components.

The storage apparatus 24 can use various forms of storage apparatuses such as a hard disk and a magnetic disk. Such storage apparatus 24 or the ROM 21 stores the program shown by FIGS. 6 and 7 of the present invention so that the CPU 20 executes them, thereby enabling a determination of the initial value of the upper limit error value and a narrow-down thereof to the minimum value according to the present embodiment.

Such programs can be provided by a program provider 28, stored by the storage apparatus 24, for example, by way of a network 29 and the telecommunication interface 23, or stored by a portable storage medium 30 which is commercially available through distribution, then set in the read apparatus 26 and executed by the CPU 20. The portable storage medium 30 can utilize various forms of storage media including CD-ROM, a flexible disk, an optical disk, a magneto optical disk, a DVD, et cetera. The program stored by such storage media is read by the read apparatus 26, thereby enabling a determination of model parameters using the minimum value of the upper limit error value according to the present embodiment.

What is claimed is:

1. A recording medium recording a program for making a computer execute a model parameter determination method, wherein
the model parameter determination method comprises the procedures of
substituting variable values and differential values of variables, computed by using initial values of the variables and the model parameters for a first-order formula corresponding to the model;
substituting supposition values for unknown model parameters for the first-order formula which is substituted by the variable values and differential values of variables; and
applying a quantifier elimination method to the first-order formula which is substituted by the supposed parameters, thereby obtaining an upper limit error value corresponding to a plurality of error terms within the aforementioned first-order formula.

2. The recording medium according to claim 1, wherein said procedure of substituting supposition values for said model parameters further substitute, for said first-order formula, approximate values for variables except for at least one variable among those of the model.

3. The recording medium according to claim 1, wherein
said program further makes a computer execute the procedure of narrowing down said upper limit error value to a minimum value with said obtained upper limit error value being an initial value.

4. The recording medium according to claim 3, wherein
said program further makes a computer execute the procedure of determining values of said unknown parameters within a model corresponding to a first-order formula by applying a quantifier elimination method by using said minimum value of the upper limit error value obtained by said procedure of narrowing down to the minimum value.

5. The recording medium according to claim 3, wherein
said procedure of narrowing down to the minimum value uses a binary search method with its range being between said obtained upper limit error value and a smaller value than the upper limit error value.

6. An apparatus for determining values of model parameters, comprising:
a unit for substituting variable values and differential values of variables, computed by using initial values of the variables and the model parameters for a first-order formula corresponding to the model;
a unit for substituting supposition values for unknown model parameters for the first-order formula which is substituted by the variable values and differential values of variables; and
a unit for applying a quantifier elimination method to the first-order formula which is substituted by the supposed parameters, thereby obtaining an upper limit error value corresponding to a plurality of error terms within the aforementioned first-order formula.

7. A method for determining values of model parameters, comprising:
substituting variable values and differential values of variables, computed by using initial values of the variables and the model parameters for a first-order formula corresponding to the model;
substituting supposition values for unknown model parameters for the first-order formula which is substituted by the variable values and differential values of variables; and
applying a quantifier elimination method to the first-order formula which is substituted by the supposed parameters, thereby obtaining an upper limit error value corresponding to a plurality of error terms within the aforementioned first-order formula.
